(19) United States
(12) Patent Application Publication
(10) Pub. No.: US 2017/0350473 A1
(43) Pub. Date: Dec. 7, 2017

(54) TRANSMISSION WITH NESTED GEAR CONFIGURATION

(71) Applicant: VMT Technologies, LLC, Highland, UT (US)

(72) Inventors: David S. Bennett, Herriman, UT (US); Gary D. Lee, Lehi, UT (US)

(21) Appl. No.: 15/612,829

(22) Filed: Jun. 2, 2017

Related U.S. Application Data
(60) Provisional application No. 62/345,286, filed on Jun. 3, 2016.
(60) Provisional application No. 62/422,412, filed on Nov. 15, 2016.

(51) Int. Cl. F16H 3/30; F16H 57/08; F16H 3/54; F16H 63/30; F16H 55/17; F16H 3/44

(52) U.S. Cl. CPC F16H 3/30; F16H 63/30; F16H 55/17; F16H 57/08; F16H 3/54; F16H 2003/442; F16H 2063/3093; F16H 2200/2005

(57) ABSTRACT

In one example, a portion of a transmission includes a first shaft, and a first gear cluster that includes a first group of coaxial nested gears that are movable in an axial direction relative to each other. The first group of coaxial nested gears includes a first gear that is fixed to the first shaft. The portion of a transmission further includes a self-centering mechanism that accommodates tolerance gaps between two successive gears of the first gear cluster.

### RELATED APPLICATIONS

The present application hereby claims priority to, and the benefit of the following patent applications: U.S. Provisional Application Ser. 62/345,286, entitled TRANSMISSION WITH NESTED GEAR CONFIGURATION, and filed Jun. 3, 2016; and, U.S. Provisional Patent Application, Ser. 62/422,412, entitled TRANSMISSION WITH NESTED GEAR CONFIGURATION, and filed Nov. 15, 2016. All of the aforementioned applications are incorporated herein in their respective entireties by this reference.

### FIELD OF THE INVENTION

Embodiments of the present invention generally concern mechanical transmissions and related systems and components. More particularly, at least some embodiments of the invention relate to transmissions that employ a nested gear configuration.

### DESCRIPTION OF THE FIGURES

In order to describe the manner in which at least some aspects of this disclosure can be obtained, a more particular description will be rendered by reference to specific embodiments thereof which are illustrated in the appended drawings. Understanding that these drawings depict only example embodiments of the invention and are not therefore to be considered to be limiting of its scope, embodiments of the invention will be described and explained with additional specificity and detail through the use of the accompanying drawings, in which:

FIG. 1 discloses an example of a transmission including two nested clusters of gears;

FIG. 2 is a front view that discloses an example transmission with variable center-to-center distances effected with the use of pivot arms;

FIG. 3 is a rear view of the example of FIG. 2 and discloses two nested gear clusters with moveable center-to-center distances shown with a different gear ratio than in the example of FIG. 2;

FIG. 4 discloses multiple paths of an example implementation of recirculating ball bearings;

FIG. 5 is an end view of an example nested gear riding on center gear with 6 recirculating ball bearing paths;

FIG. 6 discloses a recirculating bearing path shown in partial end view of a nested gear;

FIG. 7 discloses an example of a design for a retaining plate with integrated ball bearing return paths and pick up fingers;

FIG. 8 discloses aspects of a finite element analysis of a nested gear with a tooth being loaded and ball bearing preload;

FIG. 9 discloses example ring and sun nested gear clusters shown with their nested gears retracted toward the same side;

FIG. 10 discloses an example planet nested gear cluster with all nested gears retracted (outer ring gears not shown for clarity);

FIG. 11 is a layout sketch of an example nested gear planetary system;

FIG. 12 is a chart of some example gear states and the resulting speed ratios (shown in bold);

FIG. 13 discloses a planetary transmission showing one of five possible gear states.

FIG. 14 is an overview of a transmission exterior;

FIG. 15 shows some interior transmission components, with gears disengaged;

FIG. 16 is similar to FIG. 15, but with gears engaged;

FIG. 17 is similar to FIG. 16, but with a different gear configuration;

FIG. 18 shows an example transmission and housing;

FIG. 19 discloses an example hydraulic union;

FIG. 20 discloses an example power shaft;

FIG. 21 discloses an example nested gear cluster outer housing;

FIG. 22 discloses an example transmission and control paddles;

FIG. 23 discloses an example transmission gear;

FIG. 24 discloses an example transmission gear retraction actuator;

FIG. 25 discloses further details of a transmission gear retraction actuator;

FIG. 26 discloses further details of a gear retraction actuator piston and push plate;

FIG. 27 discloses a gear retraction actuator in an extended position;

FIG. 28 discloses a gear retraction actuator and stationary housing;

FIG. 29 discloses an example transmission and activated gear retraction actuator;

FIG. 30 discloses a transmission and control paddle;

FIG. 31 discloses a transmission and control paddle;

FIG. 32 is an end view of FIG. 31;

FIG. 33 discloses an arrangement of cluster gears;

FIG. 34 discloses another arrangement of cluster gears;

FIG. 35 discloses an example gear ring;

FIG. 36 discloses a transmission housing for a belt/chain driven transmission;

FIG. 37 shows interior components of the transmission of FIG. 36;

FIG. 38 discloses an example output shaft;

FIG. 39 is a section view of the output shaft of FIG. 38;

FIG. 40 discloses an example input or output center drive shaft;

FIG. 41 discloses an example of a single nested gear;

FIG. 42 discloses an example arrangement of nested gear sets;

FIG. 43 is a cross-section of the arrangement of FIG. 42;

FIG. 44 is a detail view of the arrangement of FIG. 42; and

FIG. 45 is another cross-section of the arrangement of FIG. 42.

### DETAILED DESCRIPTION OF SOME EXAMPLE EMBODIMENTS

In at least some example embodiments, a transmission is provided that includes two opposing sets of nested gears, where each gear in one set has a counterpart gear in the other set. The gears in a set are splined so that they can each move axially relative to each other, but are prevented from rotating relative to each other. The two sets of gears are mounted opposite each other on a shaft so that the gears, which have a generally tubular configuration, can move toward and away from each other in an axial direction along the shaft.

Extension of the gears toward each other results in the exposure of the teeth of those gears so that they are positioned to engage a belt/chain or external gear, while retraction of the gears away from each other conceals the teeth of those gears within another of the nested gears so that the retracted gear is not engaged with the belt/chain or external gear. Because each gear in a set has a different diameter, the effective diameter of the shaft can be varied by moving corresponding gears in the two sets either toward, or away from, each other axially along the shaft. The different shaft diameters defined by the extension or retraction, as applicable, of the gears each correspond with a respective gear ratio.

As well, in at least some embodiments, a center-to-center distance between two clusters of nested gears is controllable and variable. For example, one nested gear cluster can be fixed and the second cluster pivoted using a pivot arm in such a way as to keep a gear that is part of the moving nested gear cluster to remain in mesh with a second gear concentric with the fixed pivot end of the pivot arm.

Applications for the disclosed technology are wide ranging. For example, various embodiments of the invention can be employed in wind turbines, water turbines, and any type of land vehicle, watercraft, and aircraft. Due to the relatively compact nature of at least some embodiments, the size of vehicles and craft where example transmissions are employed can vary widely as well. For example, embodiments can be constructed that are small enough for use in relatively small vehicles such as gas-powered scooters, motorcycles, and snow machines. Moreover, the ready scalability of embodiments of the invention also enables transmissions that are large enough and powerful enough for use in long haul trucks, ships and aircraft.

### A. Aspects of Some Particular Example Embodiments

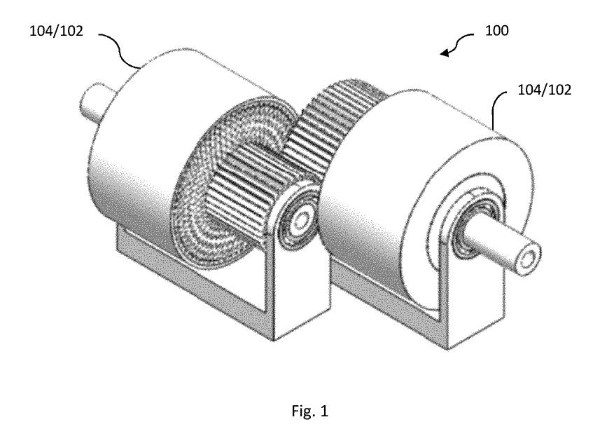

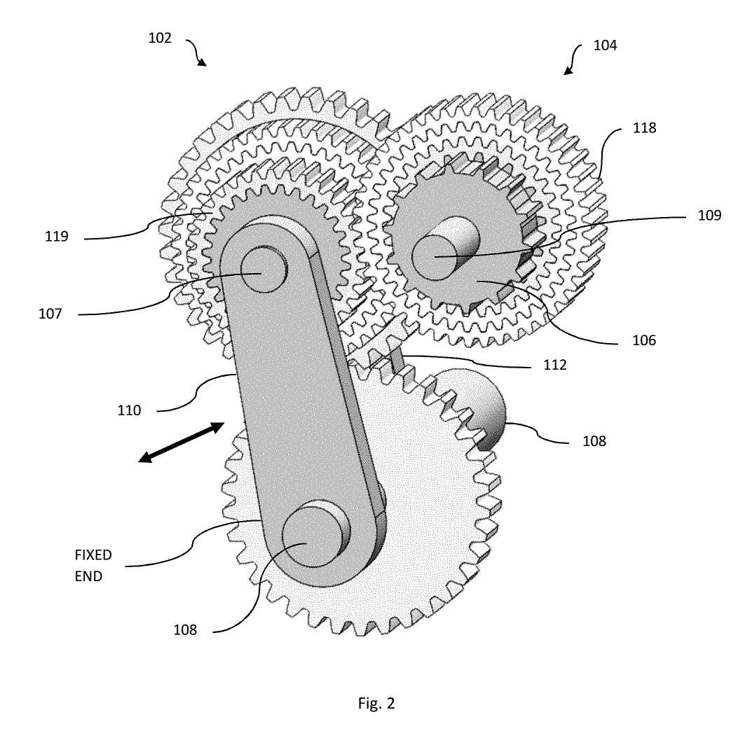

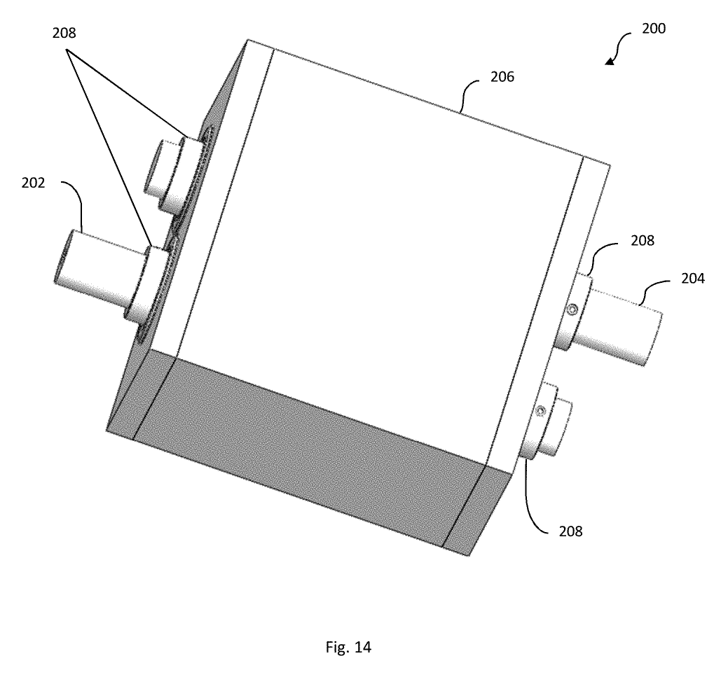

Reference is first made to FIGS. 1-13, which disclose aspects of various example embodiments. FIGS. 14-45 are addressed following the discussion of FIGS. 1-13. With specific reference now first to FIG. 1, an arrangement 100 is indicated that provides for variable center-to-center distances by fixing one nested gear cluster 102 and translating the other nested gear cluster 104, although the reverse configuration could also be employed. As disclosed herein, and with particular reference now to the example of FIGS. 1 and 2, one way to vary the center-to-center distances between the illustrated nested gear clusters is by fixing one nested gear cluster 102 and by pivoting a second nested gear cluster using a pivot arm 110/112 in such a way as to keep a gear that is part of the moving nested gear cluster to remain in mesh with a second gear concentric with the fixed pivot end of the pivot arm 110/112.

With continued reference to FIG. 2, which discloses variable center-to-center distances using pivot arms, the gear 106 on the upper right is the input. The shaft 108 on the bottom is the output. The input shaft 109 and output shaft 108 are fixed, but the cluster of nested gears on the upper left and mounted to shaft 107 can pivot on the two arms 110/112 (in FIG. 2—one at the front and one at the back) about the fixed output shaft 108 in such a way as to create various center-to-center distances between the two nested gear clusters 102 and 104, thus resulting in a relatively greater number of total gear combinations and gear ratios.

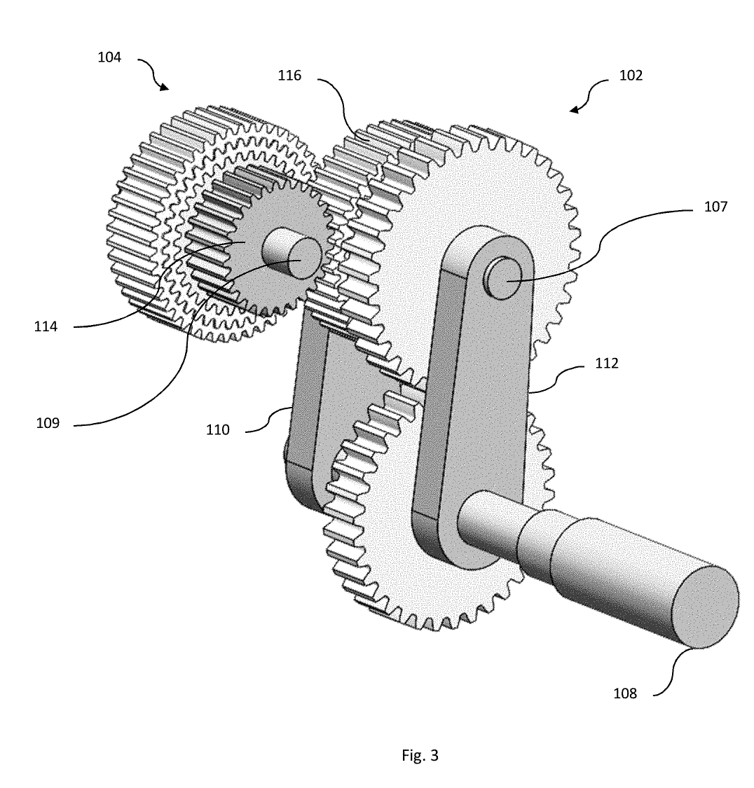

Turning now to FIG. 3, which discloses two nested gear clusters 102 and 104 with moveable center-to-center radial distances between the shafts 107 and 109, where FIG. 3 is a rear view of the example of FIG. 2 and shows the smallest gear 114 of the input nested gear cluster 104 engaged with the largest gear 116 of the movable output nested gear cluster 102. Thus, FIG. 3 indicates a different gear ratio than in FIG. 2. In the example of FIG. 2, the largest input gear 118 was shown engaged with one of the smaller gears 119 of the movable cluster. Using this technique and with the given nested gears as shown, sixteen (16) distinct gear states can be achieved. However, since some of the ratios may be very close in value to others, the number of practical distinct gear states in the above example configuration is nine (9).

In general, there are practical limits to the number of nested ring gears that can be engineered into a cluster. A minimum wall thickness of the nested ring gear must be maintained to provide mechanical rigidity. In some circumstances at least, it has been found that there needs to be approximately six additional teeth or more for each subsequently larger nested ring gear if the strength and fatigue life of the ring gear is to be, for practical purposes, undiminished as compared to a solid gear or the same outer tooth design. The value for the number of additional teeth in this illustrative example was determined using FEA and 20-degree stub-involute teeth.

However, larger numbers of teeth for each subsequently larger nested ring gear may be required when standard involute profiled teeth are used in a given design. The minimum number of additional teeth required might be reduced or stay the same when using a helical angle on the teeth. This is because there is a slight strengthening factor that occurs with the helical pattern since it creates occasional complex curved sections of reduced thickness which are less susceptible to bending since these cross sections are not parallel to the center axis of the ring gear.

A further consideration in the design of at least some example embodiments concerns manufacturing tolerance between the outside diameter of one ring gear and the inside diameter of the next. In particular, if the tolerances are left relatively loose, then the gear rings may be thrown off center by centripetal forces which cause the gaps between successive gear rings to all be taken up in one direction. If the tolerances are held relatively tighter, manufacturing cost may climb quickly, the friction of the telescoping action of the nested gears can increase, and/or the nested gear clusters become susceptible to contamination.

One solution within the scope of the invention that may resolve one, some, or all, of the problems that may result from tolerance stacking as just described is to inject pressurized hydraulic fluid into the gaps between the gears. This would reduce the telescoping frictional forces as well as act as a radial centering force. That is, the hydraulic fluid would form a hydrodynamic bearing. If the gaps between the nested gears are held relatively tight, then the gap stiffness will be very high and strong centering forces would exist.

Another approach to resolving the accumulating gap problem is to incorporate multiple recirculating ball bearing paths around the circumference of the ring gears at the interface between nested ring gears. The ball bearings are preloaded in order to solve the tolerance problem. Otherwise, the tolerance problem would be reduced in that high precision is only required at the ball bearing interface, but this could still be expensive to realize. Following is a discussion of some examples of ways in which a ball bearing system might be implemented to possibly resolve problems such as those noted above.

Another approach to resolving the accumulated gap while also providing for a reduction in manufacturing costs is to allow larger clearances through the majority of the splined surfaces and only provide an area of tighter tolerance in front and rear zones where the gears are fully extended of retracted. This might be accomplished with a slight conical taper in the narrow zone.

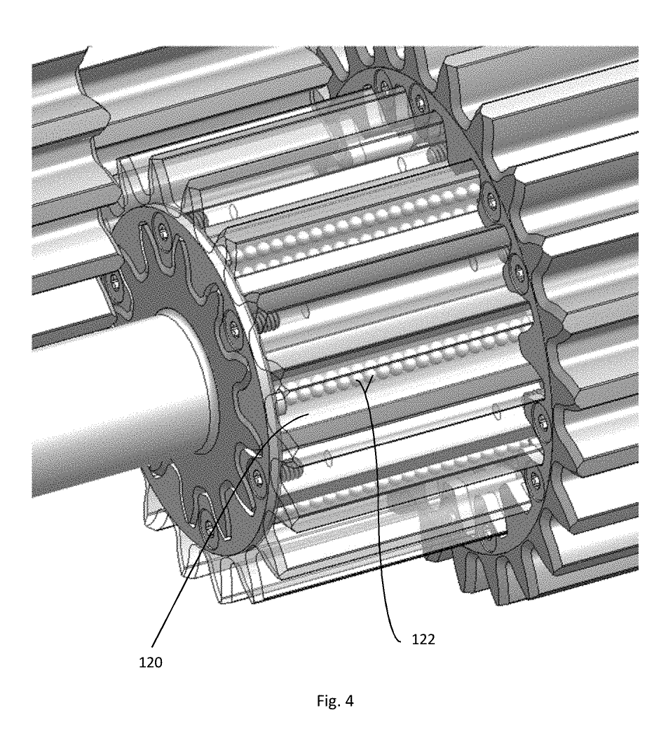

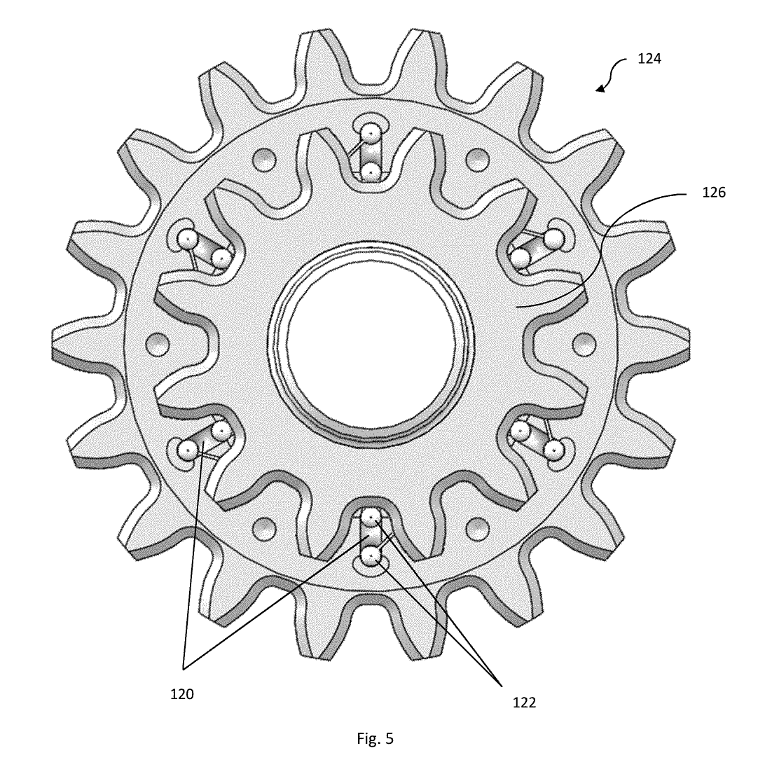

As shown in FIG. 4 and FIG. 5, multiple axial paths 120 of recirculating ball bearings 122 can be implemented to allow smooth, low friction telescoping action in the axial direction of the nested gears while providing high pre-loaded support in the radial direction. FIG. 5 particularly discloses an end view of a nested gear 124 riding on a center gear 126 with 6 recirculating ball bearing paths. In other embodiments, more, or fewer, recirculating ball bearing paths can be used.

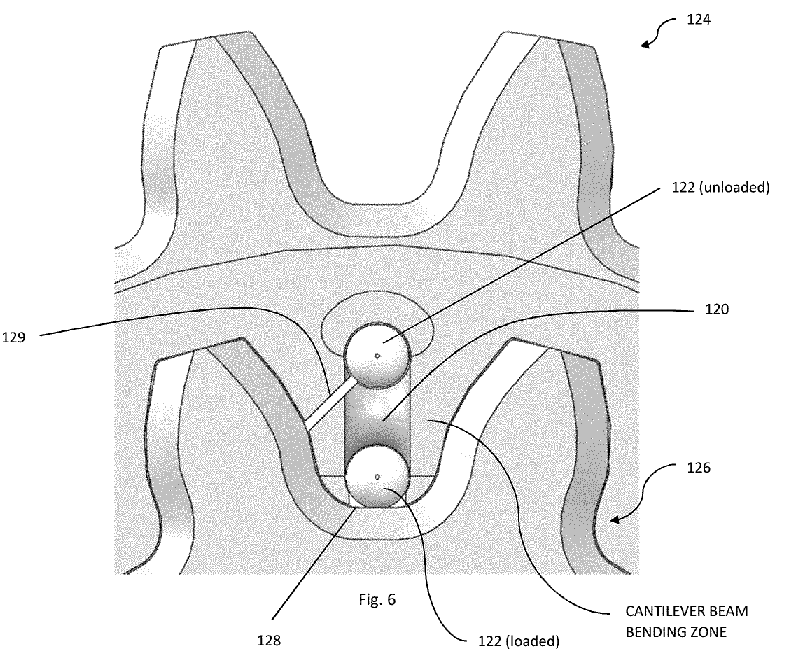

The example of FIG. 6 shows a partial end view of a nested gear. A lower key-hole shaped cutout is the axial path 120 through which the loaded bearing balls 122 travel. As shown, the balls 122 travel primarily in the axial direction, but also move radially between the two positions respectively indicated by the two balls in FIG. 6. The key-hole shape helps keep the bearing balls retained. The lower opening in the shape allows the bearing balls to contact the root area 128 of the next smaller gear, that is, the bottom gear 126 in FIG. 6. By designing an interference between the root area 128 of the smaller gear 126 and the upper surface of the key-hole shaped axial path 120, a bearing preload condition can be created. The stiffness of the pre-load is dictated by the stiffness of the cross section of the area labelled “Cantilever Beam Bending Zone.” This bending zone can be weakened by cutting the illustrated gap 129 using wire EDM or other machining techniques in order to create a softer pre-load condition. However, the pre-load stiffness should not be set below some set value at which slight concentricity errors in the center of gravity coupled with centripetal force due to spinning can cause the gears to become unbalanced and throw all the clearance gaps towards one side.

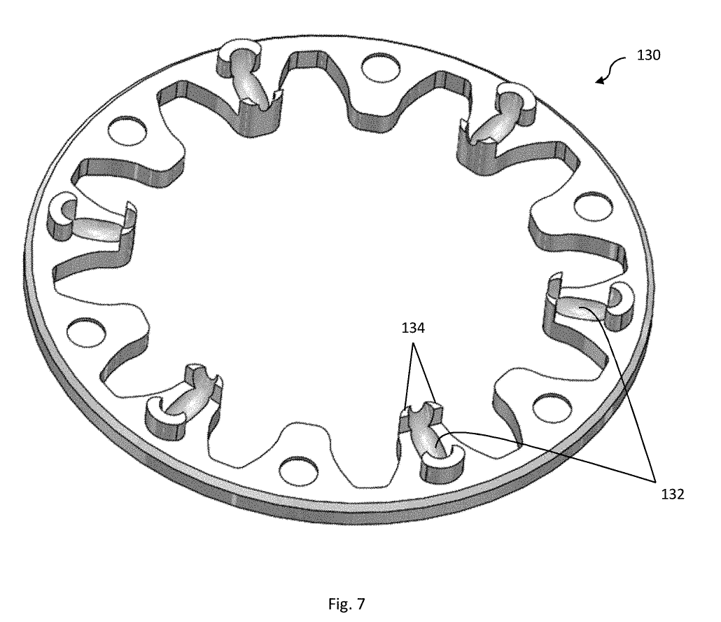

In FIG. 7, an example of one possible design for a retaining plate 130 with integrated ball bearing return paths 132 and pick up fingers 134. In this illustrative example, each nested gear has an attached retaining plate 130 on either end which has integrated ball bearing cross-over races 132 machined into them as shown in FIG. 7.

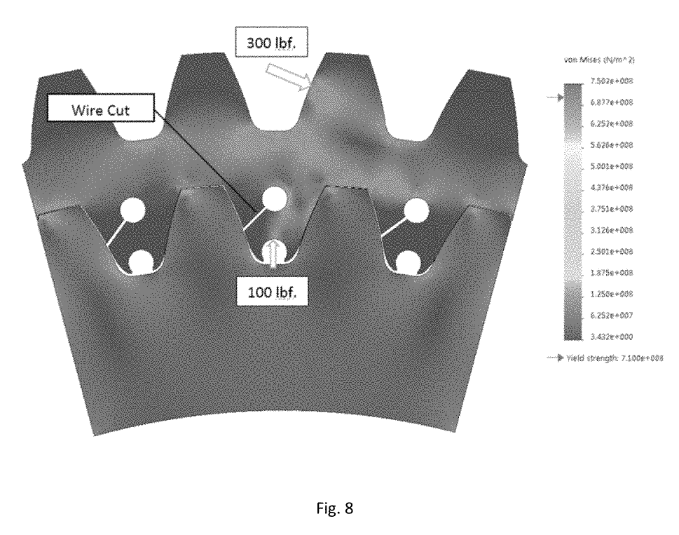

With reference now to FIG. 8, aspects of an example finite element analysis of a nested gear with a tooth being loaded and ball bearing preload are disclosed. In this example, a slit or gap between the inner cavity of a given nested gear and the outer ball bearing return path as shown in FIG. 8 is one possible method for allowing the implementation of a pre-load device. In particular, the right side of the inward facing tooth becomes a cantilevered beam. This allows the lower (loaded path) to flex upward when a slight interference of several thousands of an inch is planned into the design.

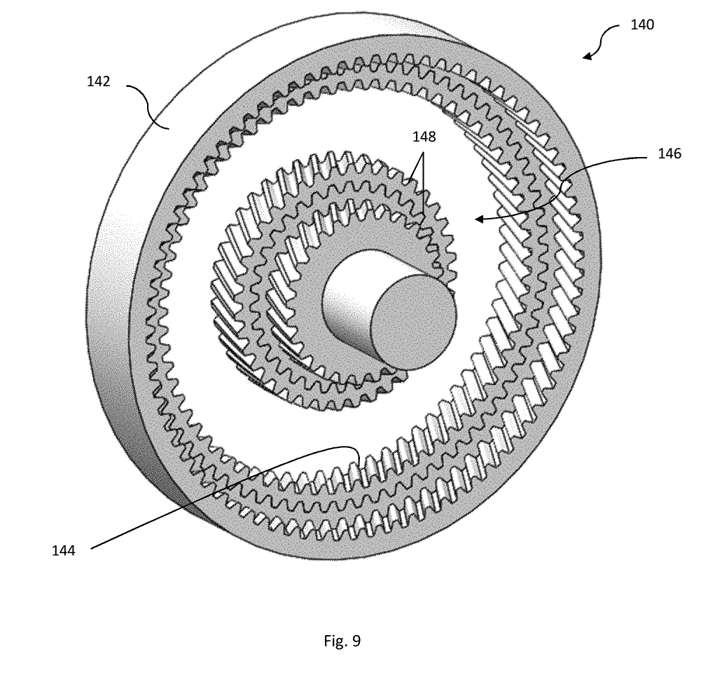

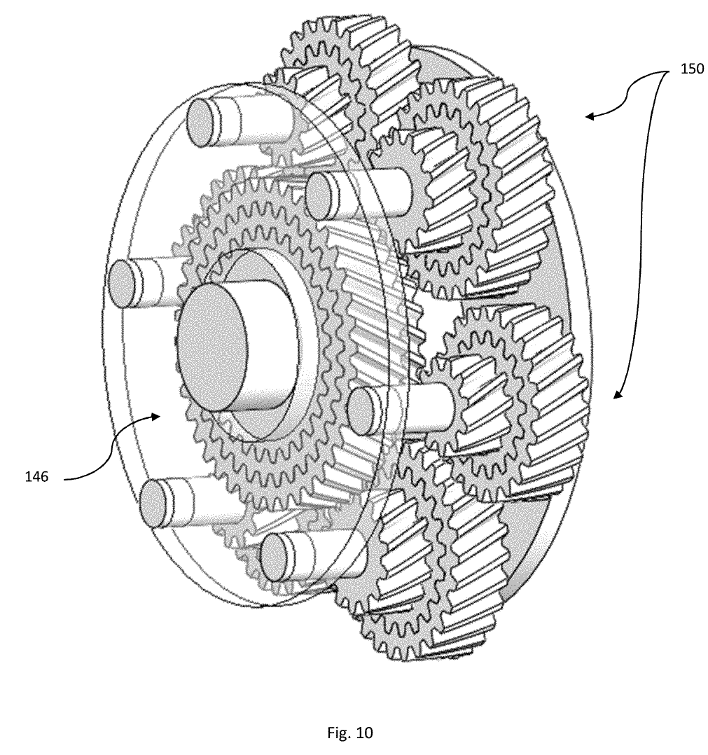

As shown in FIG. 9, some example embodiments are concerned with a planetary gearbox configuration. More particularly, an additional example embodiment of the nested gears is disclosed herein which takes the primary form of a system 140 of planetary gears. This embodiment includes an outer ring gear 142 with one of more inwardly nested gears 144, a center sun gear with one or more outwardly nested gears and a set of sun gears 146, each with one or more nested gears 148. In the illustrated example embodiment, the ring gears 142 and the sun gears 146 are arranged such that their nested gears are toward the same side of the assembly in their retracted positions as shown in FIG. 9. That is, the ring gear cluster 142 and sun nested gear clusters 146 are shown with their nested gears retracted toward the same side. This arrangement and configuration prevents the nested gears from colliding with the various ring and sun gears when not in use, as can be seen in FIG. 10.

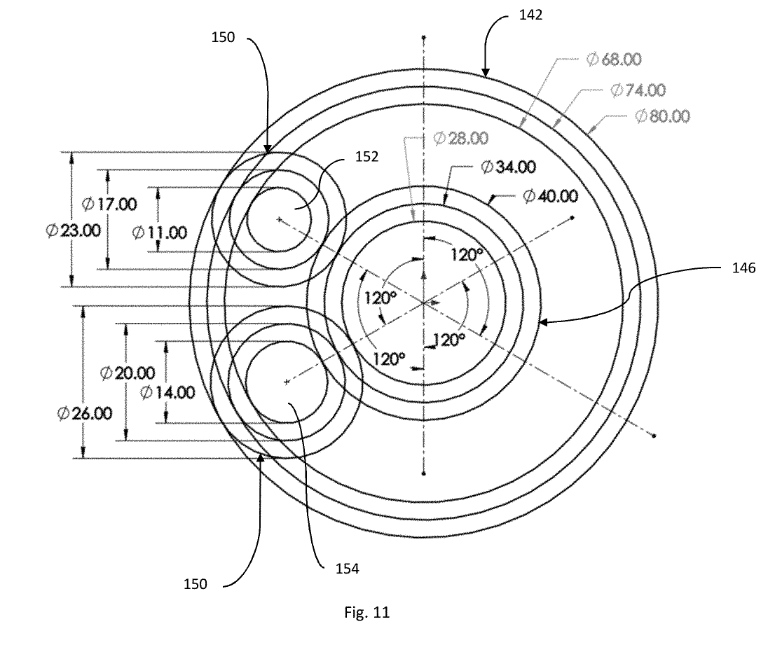

In the example configuration shown in FIG. 11, the planet gears 150 are divided into two sets of three. The lowermost set is larger than the uppermost set and they are designed such that they are exactly half the size between the two nested gears of the other set. For example, if the center gear 152 of the smaller planet set has 11 teeth with nested gears on it having 17 and 23 teeth, then the larger planetary set will have a center gear 154 of 14 teeth with nested gears having 20 and 26 teeth. Alternating between the two sets, starting with the smallest, the tooth count is 11, 14, 17, 20, 23, and 26. This arrangement allows for an increased number of gear sets to be realized while still allowing the simplified arrangement of fixed center-to-center distances of the planetary clusters on the carrier plate. The planet clusters of the same type are arranged 120 degrees apart from each other as is common on planetary gears with the second set fitting in the spaces in between, offset 60 degrees from the first set.

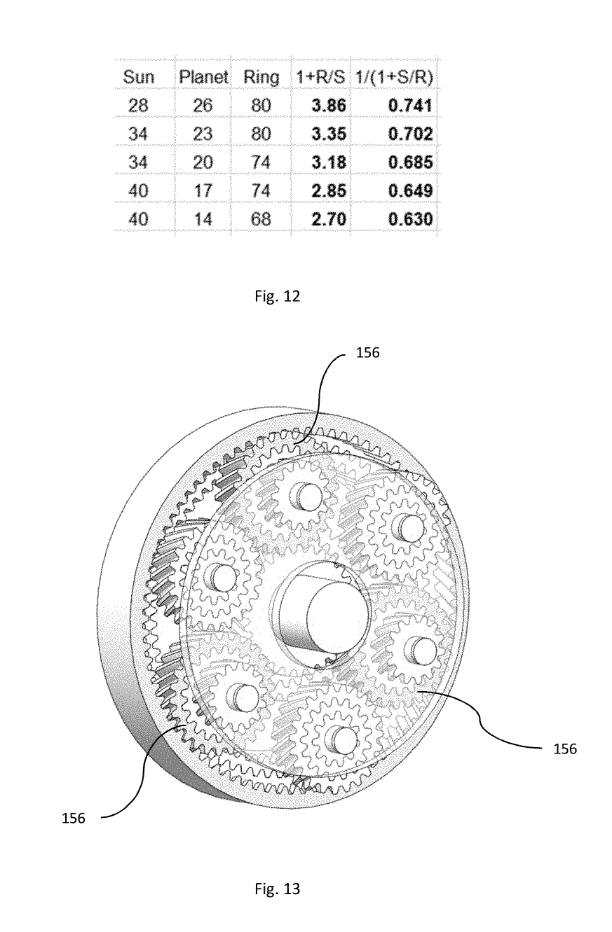

As shown in the example chart of FIG. 12, there are various possible gear combinations for one of the examples disclosed herein. The resulting speeds are shown in bold. These speeds can be shifted and scaled by other gears to create the final desired gear ratios and overall ratio spread. The basic relationships explicit, inherent, and/or implied, in FIG. 12 can be extended to other embodiments having gears with different configurations than those of FIG. 12. FIG. 13 shows the engaged gears 156 for one of the five possible, in this example embodiment, gear states. Ten forward speeds can be realized by changing which elements are grounded (fixed) and which element in the input. This example system can also be designed to produce 5 reverse speeds.

### B. Aspects of Some Additional Example Embodiments

Directing attention now to FIGS. 14-45, details are provided concerning further example embodiments. In at least some example embodiments, a transmission is provided that includes two opposing sets of nested gears, where each gear in one set has a counterpart gear in the other set. The gears in a set are splined so that they can each move axially relative to each other, but are prevented from rotating relative to each other. The two sets of gears are mounted opposite each other on a shaft so that the gears, which have a generally tubular configuration, can move toward and away from each other in an axial direction along the shaft.

Extension of the gears toward each other results in the exposure of the teeth of those gears so that they are positioned to engage a belt/chain or external gear, while retraction of the gears away from each other conceals the teeth of those gears within another of the nested gears so that the retracted gear is not engaged with the belt/chain or external gear. Because each gear in a set has a different diameter, the effective diameter of the shaft can be varied by moving corresponding gears in the two sets either toward, or away from, each other axially along the shaft. The different shaft diameters defined by the extension or retraction, as applicable, of the gears each correspond with a respective gear ratio.

Directing attention now to FIG. 14, one relatively simple embodiment 200 of the disclosed transmission has an input power shaft 202 and an output power shaft 204 with those shafts being held at fixed center-to-center radial distances by a housing 206. Bearings 208 hold the shafts 202 and 204 at the fixed radial distances. This can be accomplished, for example, by bearings 208 being spread apart as shown in FIG. 14 for example, or by a single bearing 208 per shaft 202 and 204 with sufficient rigidity to allow the gears in the transmission to function on a cantilevered shaft.

The inner workings of some example embodiments of the transmission include two sets of radially nested gears that spline together using the exterior tooth profile of an inner gear as the interior spline profile of the next larger gear. These nested gear clusters are arranged such that there is a common overlapping engagement zone.

In order for the gears to be engaged and active, one gear and all the gears smaller than that gear must be extended out of the retracted cluster and the complementary/matching gear and all of the gears smaller of the second retracted cluster must also be extended. The innermost gear does not retract, but is machined on or otherwise permanently attached to the main power shaft.

TABLE 1

| Gear Cluster 1 | Gear Cluster 2 |
|---|---|
| 1 (inner fixed) | 6 (outermost) |
| 2 | 5 |
| 3 | 4 |
| 4 | 3 |
| 5 | 2 |
| 6 (outermost) | 1 (inner fixed) |

(gear matches needed for gear engagement to occur)

For example, if there are 6 gear faces and Gear Cluster 1 has all but the inner gear face retracted (the inner gear does not retract), then in order to have engaged gears, Gear Cluster 2 must extend all of its gears such that the 6^{th} gear of Gear Cluster 2 interfaces with the fixed inner gear of Gear Cluster 1. The gears smaller than the gears in mesh must be extended because they provide support for the gear in mesh as well as transmit the torque to or from the power shafts.

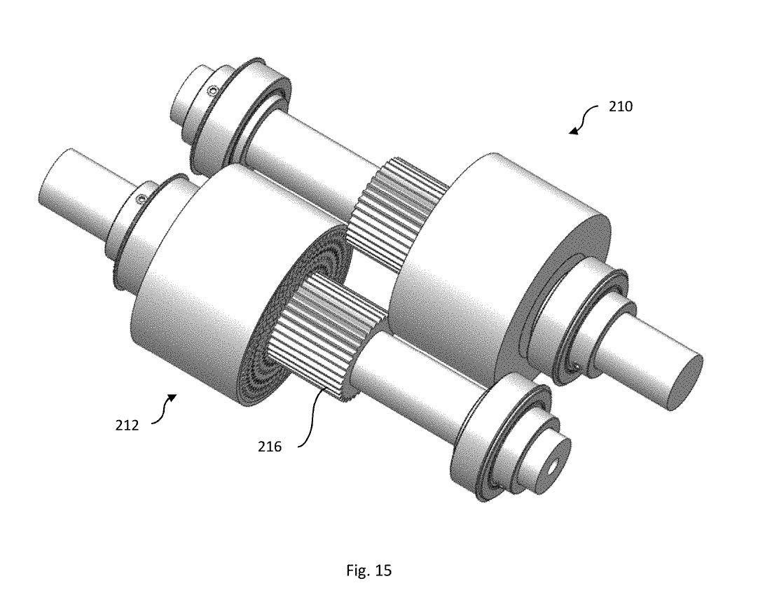

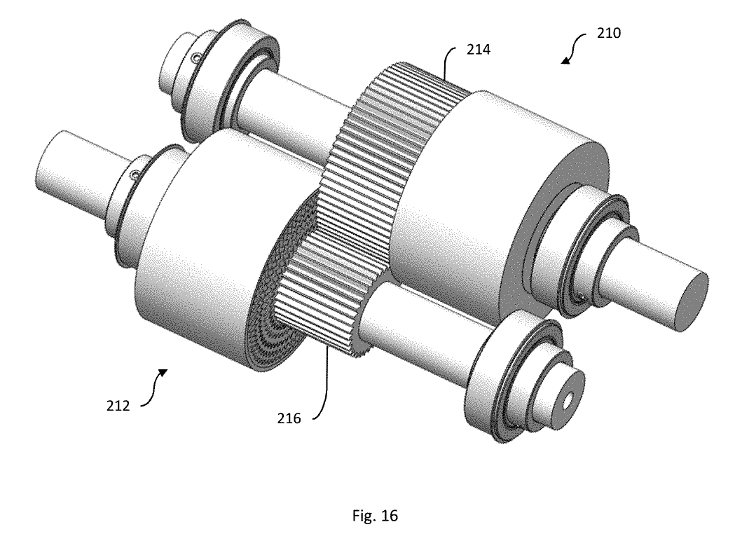

With reference now to FIGS. 15 and 16, showing a transmission engaged with the 1^{t} gear 216 from Gear Cluster 2 212 and the 6^{th} gear 214 from Gear Cluster 1 210, the example arrangement shown in FIG. 16 represents the ratio with the lowest output speed and the highest output torque for a given input speed and torque. It is the gear ratio that a user might employ, for example, to start a vehicle from a stopped condition.

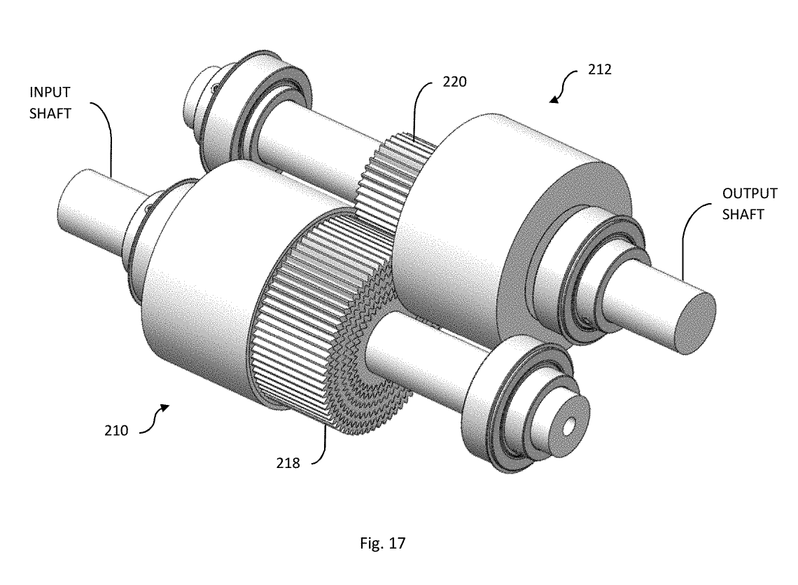

In FIG. 17, an example transmission is disclosed that indicates engagement between gear 6 218 of Gear Cluster 1 210 and gear 1 220 of Gear Cluster 2 212. The arrangement shown in FIG. 17 represents, in this particular example, the ratio with the highest output speed and the lowest output torque for a given input speed and torque. It is the gear ratio a user might employ, for example, at highway speeds where the torque requirement for the drive wheels is low but the speed requirement is high.

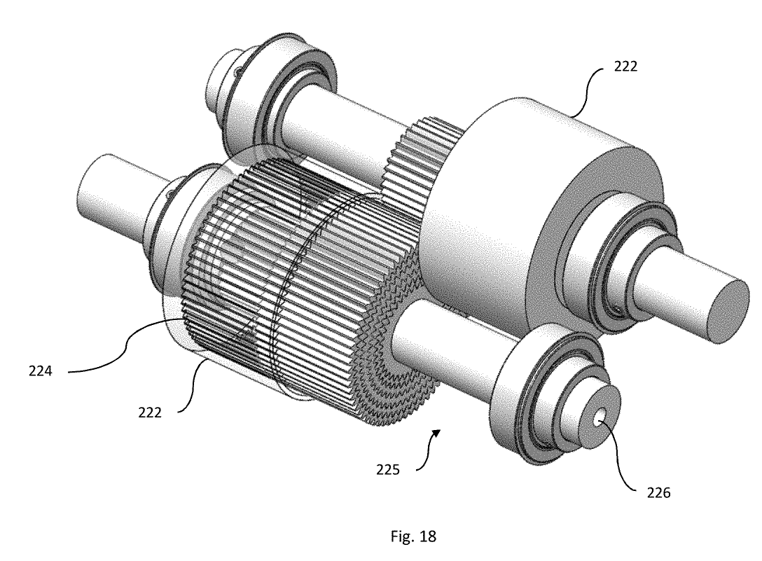

With reference now to FIG. 18, an arrangement is disclosed in which the cluster housing 222 is illustrated to be transparent, so as to enhance the clarity of the Figure. In FIG. 18, there is disclosed an outer housing 222 for each nested gear cluster. The outer housing 222 has interior profiled splines 224 to match the exterior teeth of the outer gear. The gears are of sufficient length that even when fully extended for engagement with the other cluster, a portion of their length remains engaged with the interior profiled splines 224 of the outer housing 222.

The outer housing 222 is not required for the disclosed transmission but rather it is one embodiment that allows a mechanism to extend the gears out of the cluster. Magnetic pulling devices, or other mechanical rods or plates, that can pull from the leading edge of the gears while also allowing gear rotation could also be implemented. Likewise, rods or plates pushing from the rear/trailing edge of the gears could also be used to push/extend the various gears into the engaged position.

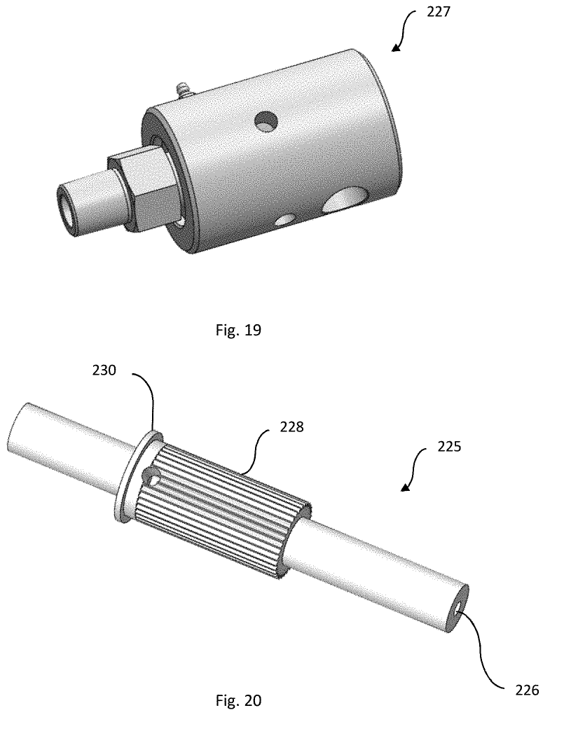

In this example embodiment, hydraulic fluid can be used to extend the gears into position. Other devices for selectively controlling which gears get extended and a method for retracting the gears are disclosed elsewhere herein. In the example of FIG. 18, hydraulic fluid enters the non-working end of the power shaft 225 through a center bore 226 via a rotary hydraulic union 227, as shown in FIG. 19, and is transmitted to a cross-drilled hole near the rear of the nested gear cluster, but interior to the housing such that hydraulic fluid is able to push the gears out of the housing.

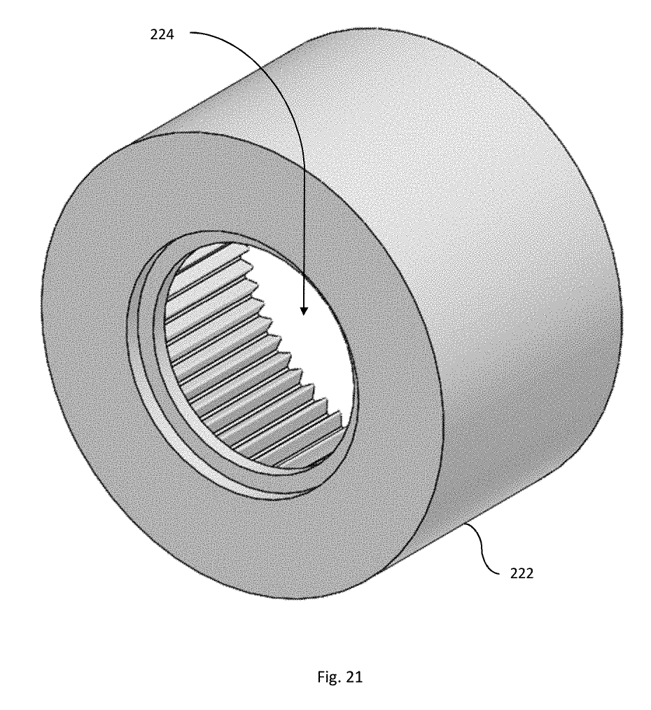

FIG. 20 discloses a power shaft 225 with integral inner gear 228, center drilled hole 226 and cross-drilled hole. The flange 230 identified in FIG. 20 is for mounting the outer housing 222 of the nested gear cluster shown in FIG. 21. The outer cluster housing 222 rotates with the power shaft 225, and is sealed at the flange 230. Due to very slight clearances that may exist between the various gear sets in the nested gear cluster, hydraulic fluid may leak out. However, this is typically not a problem since the hydraulic fluid can actually aid in the overall lubrication process of the gears and gear selection mechanisms.

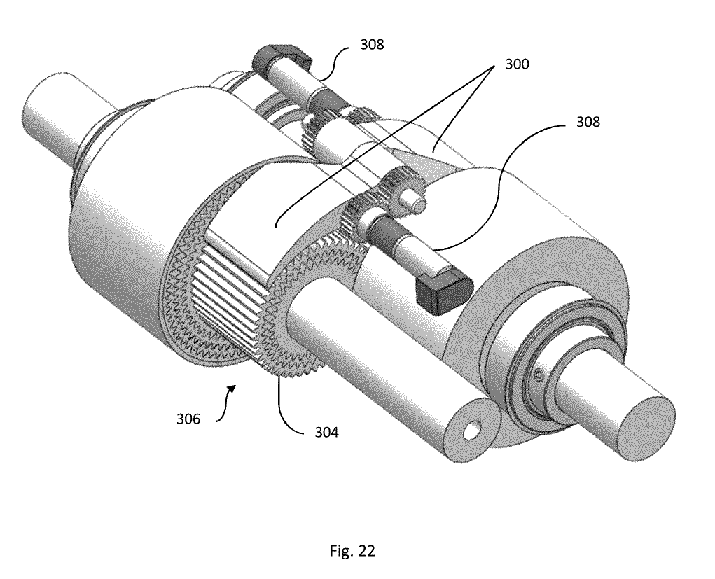

Attention is directed now to aspects of a process and configuration for selecting which gear or gears in a cluster are extended. This may be required when using the cluster housing described above because, otherwise, all the gears will be extended when pressurized hydraulic fluid is applied behind the cluster of gears. Thus, there may be a need to prevent the extension of one or more gears. Accordingly, in some embodiments, the innermost gear is prevented from being extended, and all the gears larger than that gear are all prevented from extending as a group, by the extension control paddle 300 as shown in FIG. 22.

In the particular example of FIG. 22, the extension control paddles 300, or simply “paddles,” are provided that can be set to allow two inner gears to extend for Gear Cluster 1 302 and three inner gears 304 to extend for Gear Cluster 2 306. The paddles 300 are moved into place when all the gears for Gear Cluster 1 and Gear Cluster 2 are retracted. The rotatably mounted paddles 300 can be moved into position by a motor 308 with a gear reducing gearhead. Alternatively, the paddles 300 could be moved into position by a lever which is ultimately controlled by a stick shift or cam or some other mechanism.

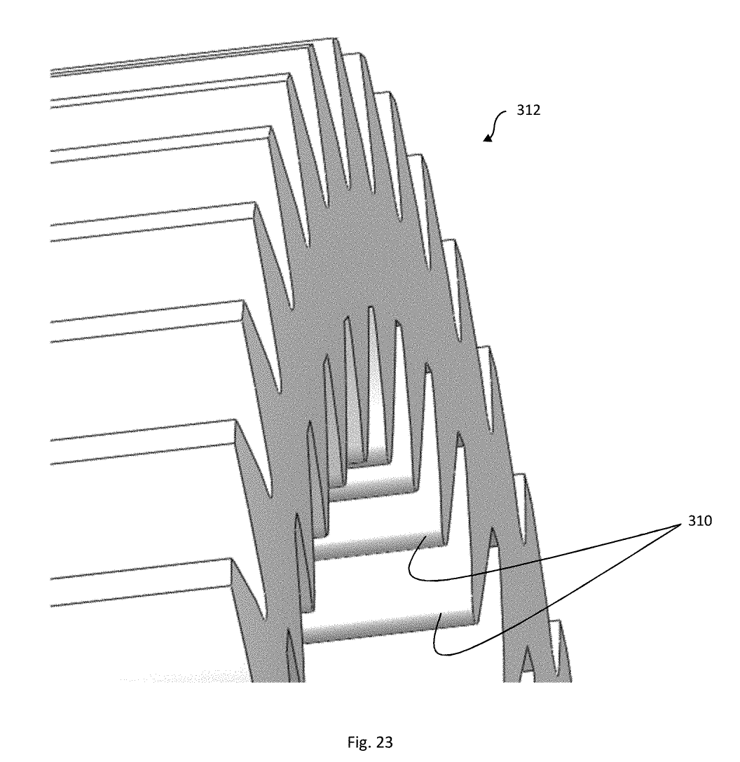

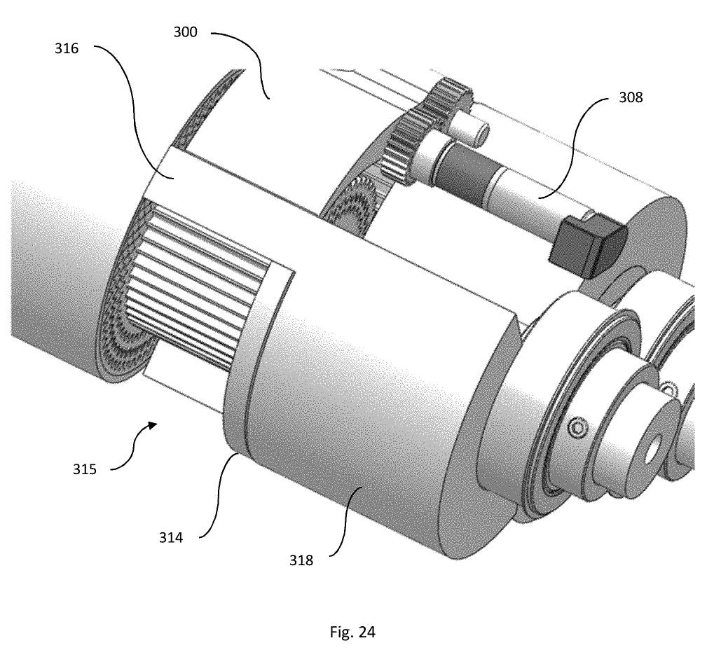

As shown in the example of FIG. 23, the leading edge 310 of each gear is crowned such that the middle, non-interrupted, section of the gear 312 contacts the paddle 300. This configuration and arrangement prevents the profiled splines from cutting into the paddle 300. Likewise, the paddle 300 and the extendible push plate 314, which is guided by a push plate support guide 316, for the gear retraction actuator 315 shown in FIG. 24 have rounded leading edges to prevent, or at least reduce, wear. With reference to FIG. 24, which discloses a gear retraction actuator shown with the gear retraction actuator 315 itself retracted allowing for gear extension, some example embodiments of the transmission have two gear retraction actuators 315, one for each nested gear cluster. When actuated, the gear retraction actuators 315 push, by way of plate 314, all of the gears back into their respective nested gear cluster housings.

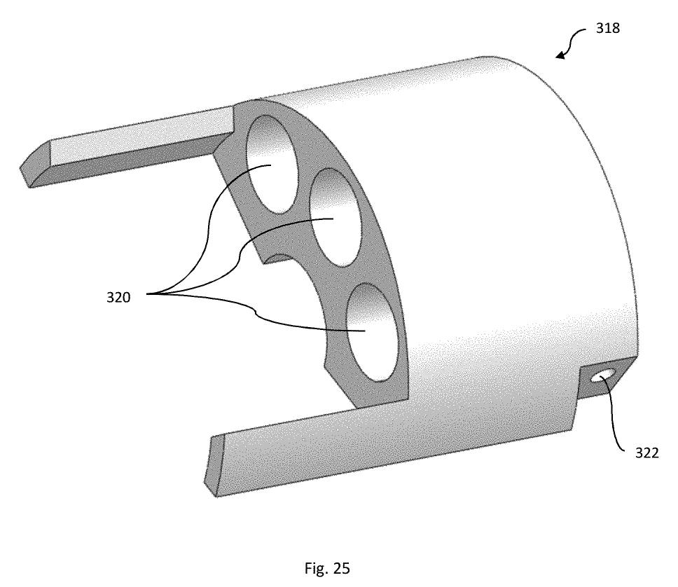

In the example stationary housing 318 shown in FIG. 25, the stationary housing 318 has three cylinders 320 into which pistons (not shown) extend and retract. A common fluid port 322, also referred to as a hydraulic extend port, connects to the bottom of all three cylinders 320 so that a single source of pressurized fluid can extend all three pistons simultaneously. The number of cylinders 320 can be varied, provided that there is sufficient area for a given pressure and flow to force the gears to retract when the pistons are extended.

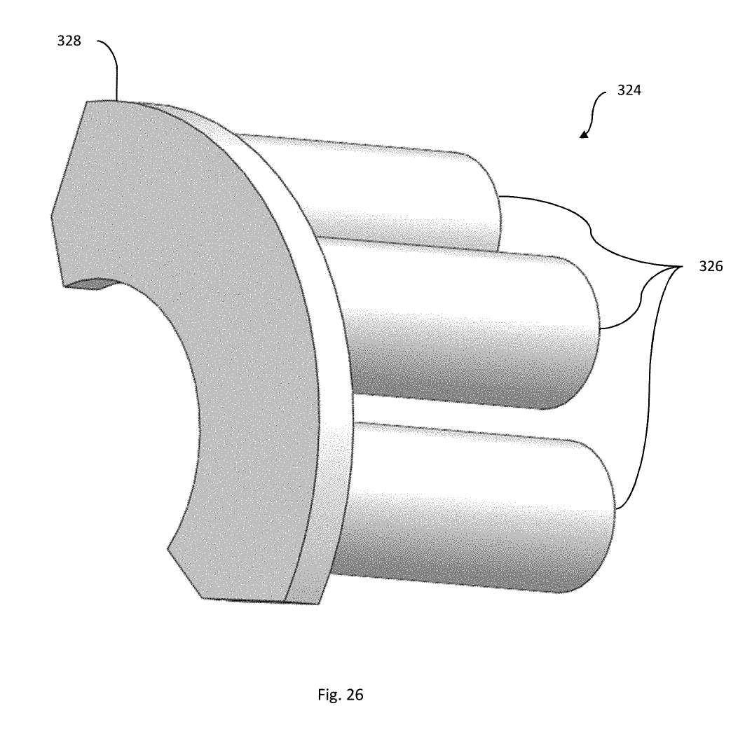

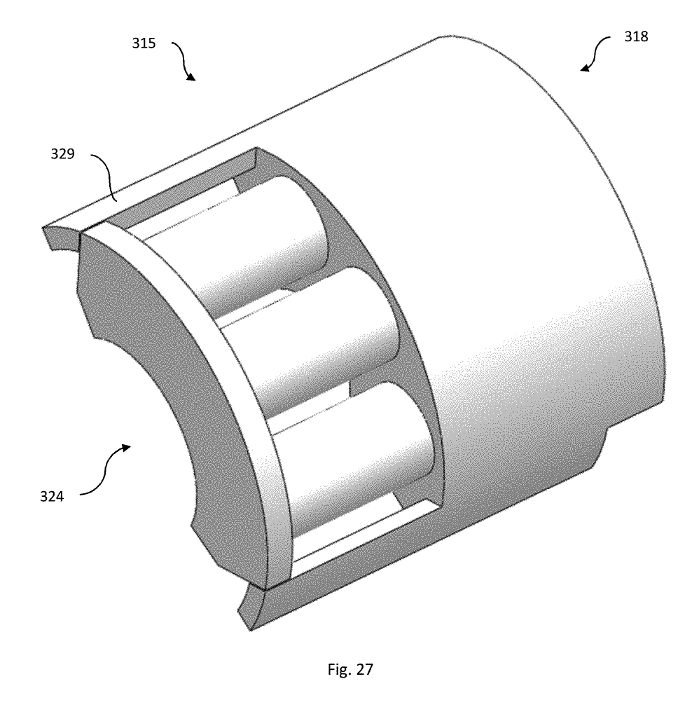

The example of FIG. 26, which discloses a gear retraction actuator piston and push plate assembly 324, shows the three pistons 326 discussed in connection with FIG. 25 all connected to a common push plate 328. When pressurized fluid is applied to the actuator, this push plate 328 pushes any extended gears back into their housing. In FIG. 27, the gear retraction actuator 315 is shown in an extended position which causes the gears to retract. The example anti-rotation support guide 329 shown in FIG. 27 helps stabilize the push plate 328 from rotating under the friction load of the gears as the gears are themselves rotating at high speed.

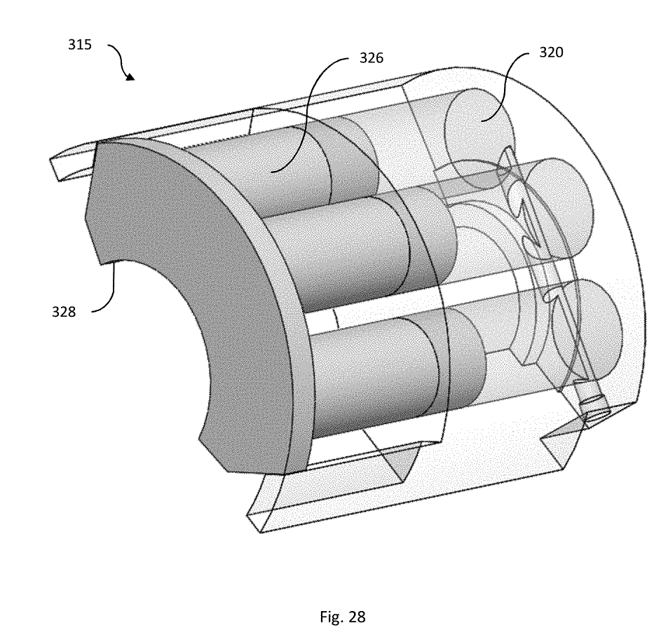

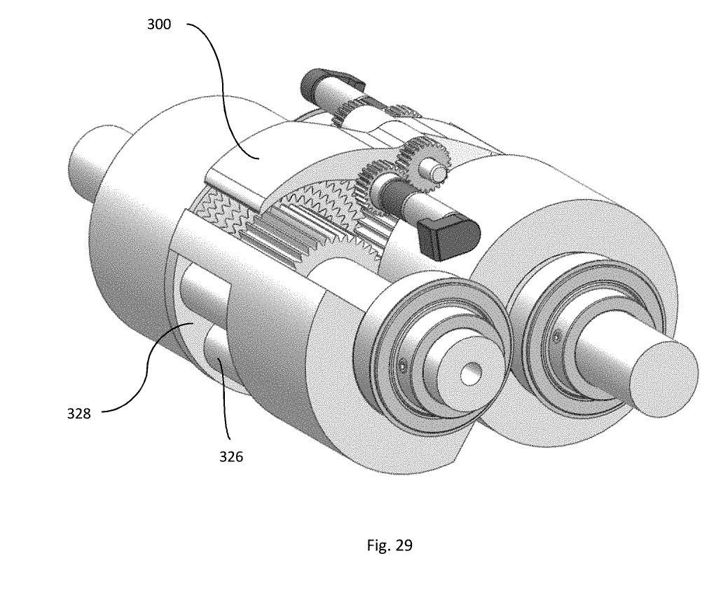

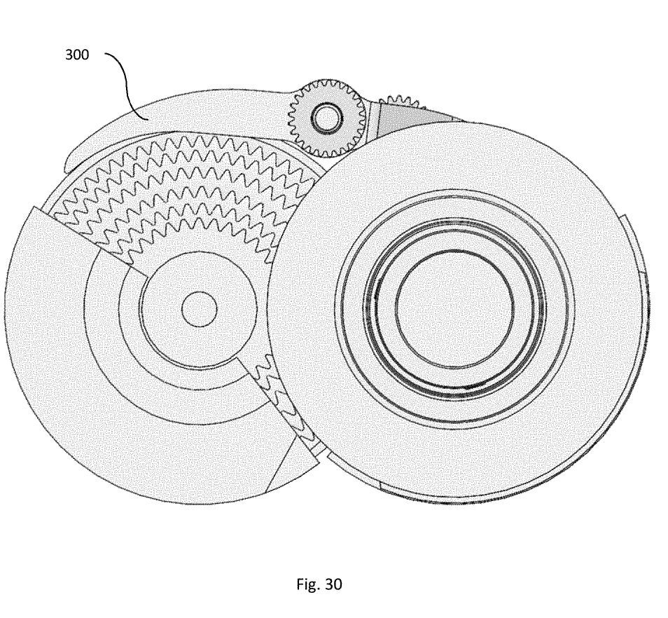

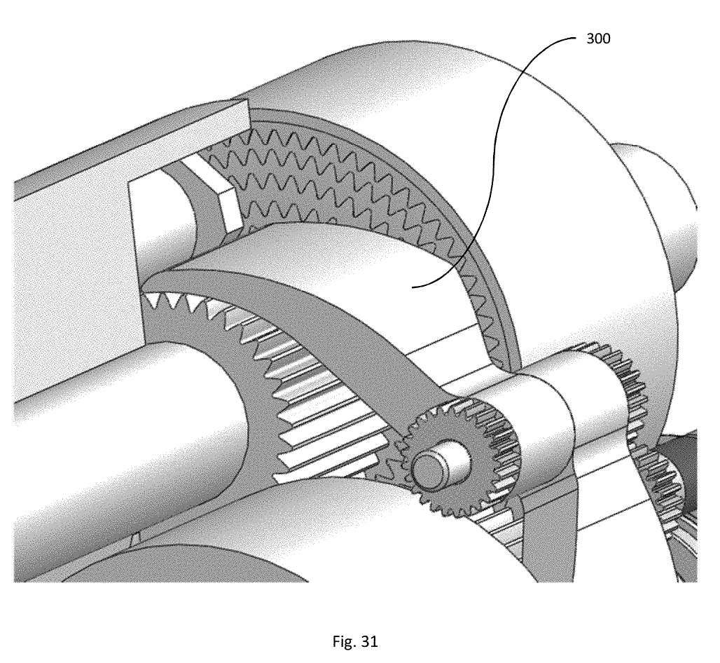

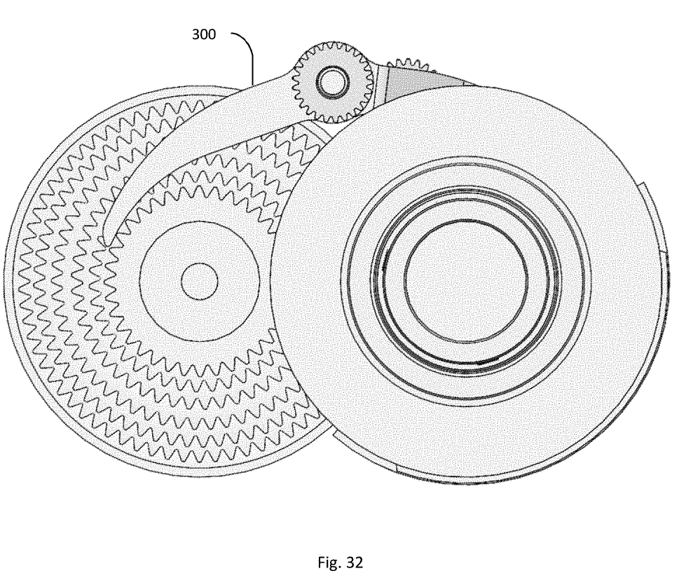

FIGS. 28-32 disclose further aspects of some example embodiments. In particular, FIG. 28 discloses a gear retraction actuator 315 with stationary housing shown transparent, FIG. 29 discloses a transmission with gear retraction actuator 315 activated so that all gears of Gear Cluster 1 are retracted, FIG. 30 discloses a paddle 300 raised high enough to allow all gears to extend, FIG. 31 discloses a paddle 300 set to block all gears from extending, and FIG. 32 is an end view of the same setup as shown in FIG. 31, but with some components removed for clarity.

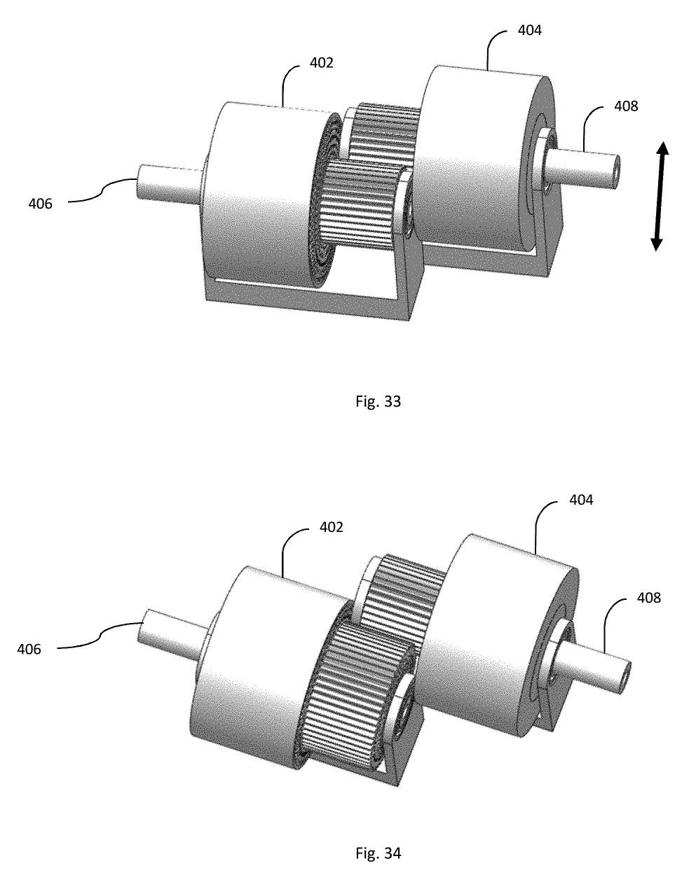

With reference next to FIG. 33, another way to configure the disclosed nested gear transmission is with variable centers between power shafts, that is, so that the center-to-center radial distances between power shaft axes can be varied. Among other things, this configuration and arrangement enables a relatively large combination of the various gears, creating more choices in gear ratios. As shown in the example of FIG. 33, one nested gear cluster 402 is stationary while the other nested gear cluster 404 can be moved closer or farther away from the first gear cluster 402 in order to mesh gears with different total diameter sums. In the example of FIG. 34, the nested gear cluster 402 has more gears extended than the same nested gear cluster in FIG. 33, but the nested gear cluster 404 just has the innermost gear exposed in both cases. In order for the gears to mesh properly for the gears in FIG. 34, the center-to-center distance of the two power shafts 406 and 408 is increased as compared to the arrangement in FIG. 33.

Various systems and mechanisms can be employed for moving the power shaft centers closer together, or farther apart from each other. For example, if the same diametral pitch (DP) teeth are used on all gears and each gear has the same number of teeth greater or lesser from the gear just inside or outside, respectively, then an arrangement of toggles can be used to set the shaft distance spacing, allowing for one or more combinations with gears that are either at the nominal center spacing or one gear spacing larger or one gear spacing smaller. This approach may not provide as many combinations of gears but the mechanism to control the center-to-center distance is simplified.

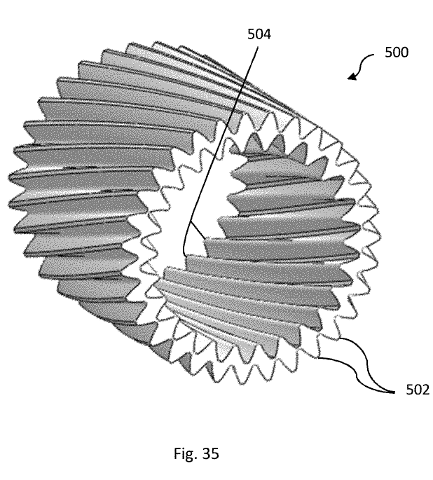

With reference now to FIG. 35, details are provided concerning some example ways in which the teeth of gear rings, such as are disclosed herein, may be cut. FIG. 35 particularly discloses a gear ring 500 with left hand outer helical teeth 502 and right hand interior helical teeth 504. One way to cut the teeth of the gear rings is to use left or right hand helical sweeps on the exterior, while using the other hand helical sweeps on the interior. This produces a very strong gear even though there may only be a very narrow web between the two teeth profiles. This allows tighter radial packing of the gear rings.

Another approach to cutting the gear rings might be to use the same helical sweep on the inside as the outside. While this arrangement may not produce a gear that is as stiff as a gear produced using the configuration in FIG. 35, the gear should be relatively stiffer than that of straight cut spur gears. This is because the thin areas that do occur where the root of the outer teeth are close to the tip of the inner teeth profile sweep at an angle, which makes the ring more stable overall.

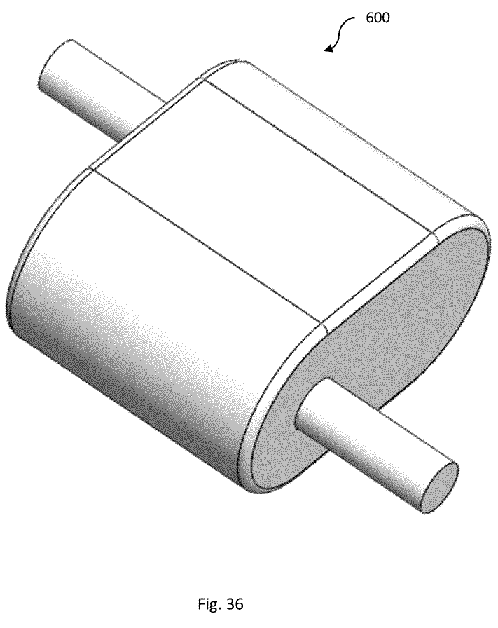

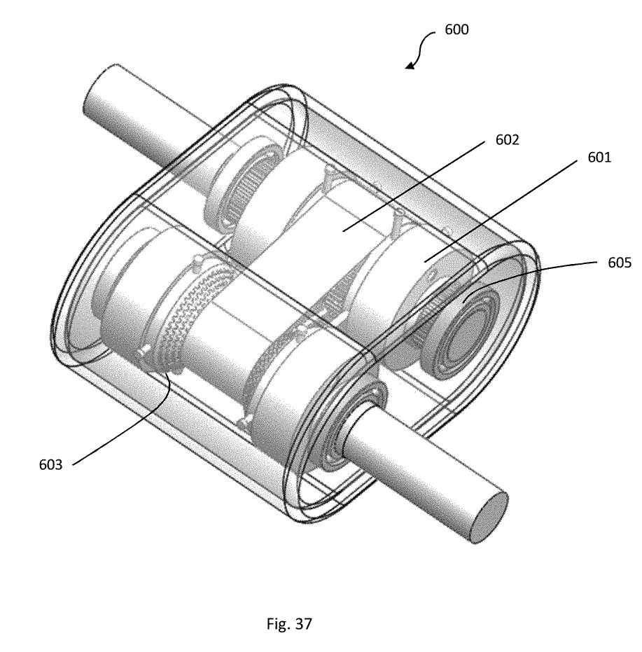

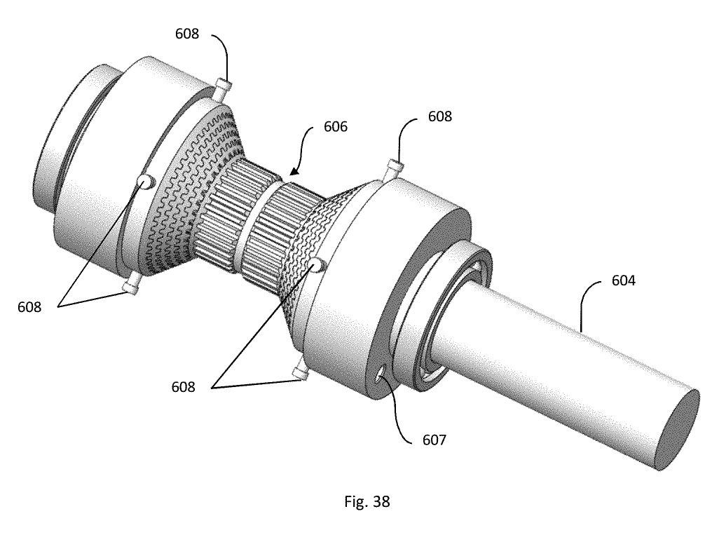

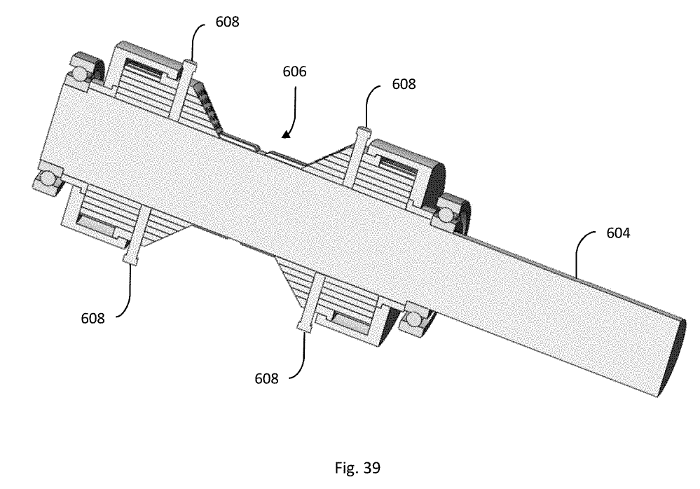

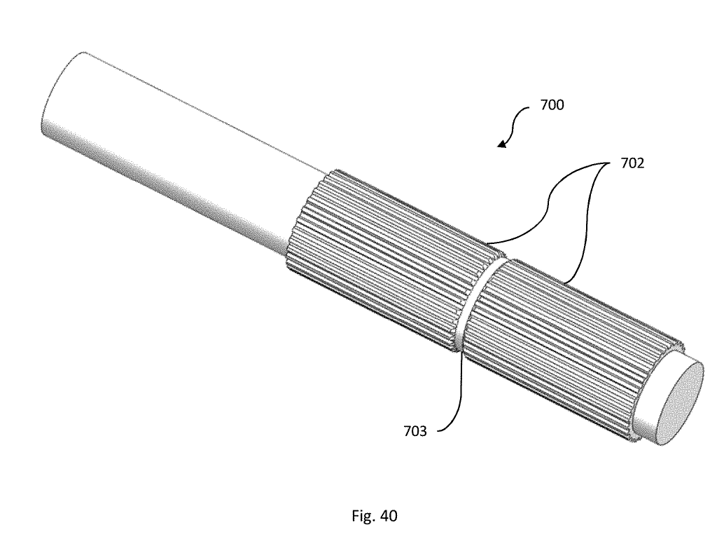

With reference next to FIG. 36, another configuration for the clustered gears is to use them with a timing belt or chain. In these types of configurations, the gears of the clusters do not engage each other but, instead, engage a driven/drive element, such as a belt or chain for example. FIG. 36 discloses aspects of a housing 600 of belt or chain variation of the design, while FIG. 37 discloses various internal components. Similar to embodiments in which the variable power shaft centers provide gear-to-gear configurations, this belt or chain 602 embodiment can enable implementation and use of a large number of gear combinations if a tensioner is used with the belt or chain. The belt 602 may or may not be a toothed belt and can include a central portion configured to be received in a guide defined by the gear sets of the gear clusters. In the particular embodiment of FIG. 38, an arrangement is disclosed that includes an output shaft 604 setup with a small diameter pulley, and FIG. 39 is a cross-section view taken from FIG. 38. As further indicated in FIG. 38, various additional components can be provided, including a shifter 601, nested gear sets 603, and bearings 605, for example.

In embodiments such as those of FIGS. 36-45, the housing and nested gears can move together as a group with both sides synchronized to create a ramp action on the belt/chain with tapered sides that can lift the belt to a larger working diameter. A mechanism/system/device for moving the nested gears and housing together is not shown, however it could take the form of a threaded nut on the outside of the actuator housing or another cylinder on the housing. Actuating hydraulic fluid can be provided to the housing by way of a hydraulic actuation port 607.

With reference to FIG. 38, selector pins 608 are moved in and out in a radial direction to select which of the nested gears can be extended under the belt/chain to create the various diameter pulleys. With this configuration, as with the nested gears, more gear states can be realized by allowing the center-to-center distances to be moved. However, with this configuration it is also possible to realize more gear states with fixed center-to-center shaft distances through the incorporation of a belt/chain tensioning system. The gear clusters can collectively form a pulley 606.

Furthermore, the tensioning system can be used advantageously to allow slack in the belt of chain while changing gear ratios. A mechanism can be added to the design that can lift the chain allowing a larger ring to be extended into the center. This basic setup has the added advantage of being able to allow the nested gear/sprocket to be full length and enter from one side only. This means the number of components can be reduced to almost half. Secondly, both nested sprocket clusters can be arranged to extend from the same size thereby making the overall package more compact.

As an alternative to the selector pins 608, relatively shorter pins (not shown) can be positioned between nested gear pairs with a spring return in the more inner of the two nested gear pairs. An external hydraulic circuit (not shown) can actuate the selector pins 608 from the outer gear into the pocket of the inner gear and lock the two together. This can be repeated at each interface with a separate hydraulic circuit with the circuits all exiting the housing and the valve located externally. The short pins would be keyed to prevent rotation so that they could also have the shape of the spline/teeth. Each spring in the lower gear of the pair would have a cap designed to not extend beyond the surface of the spline.

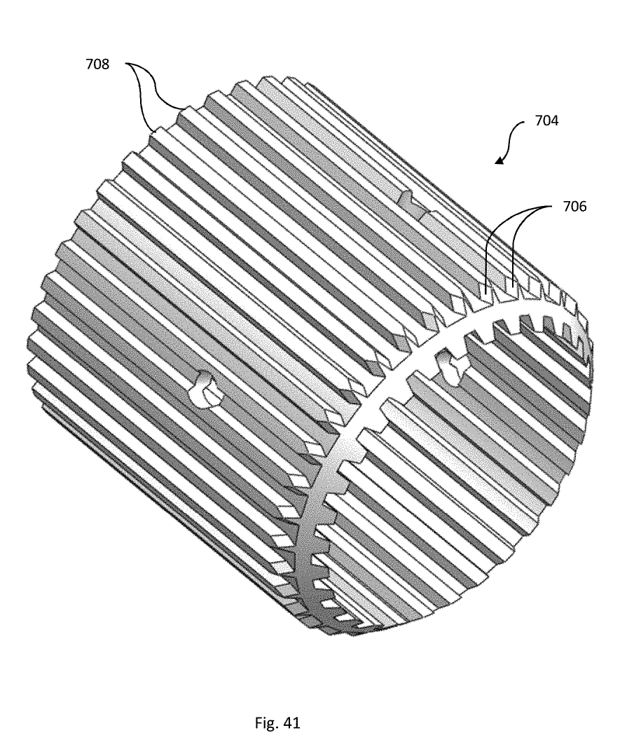

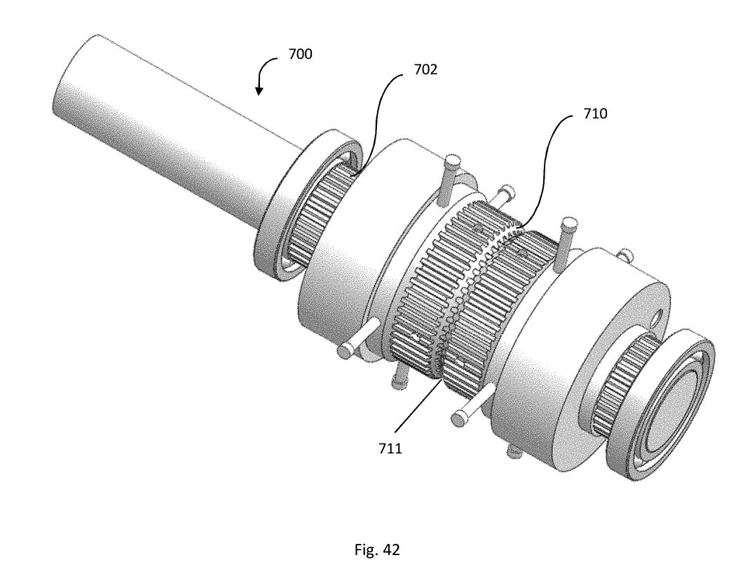

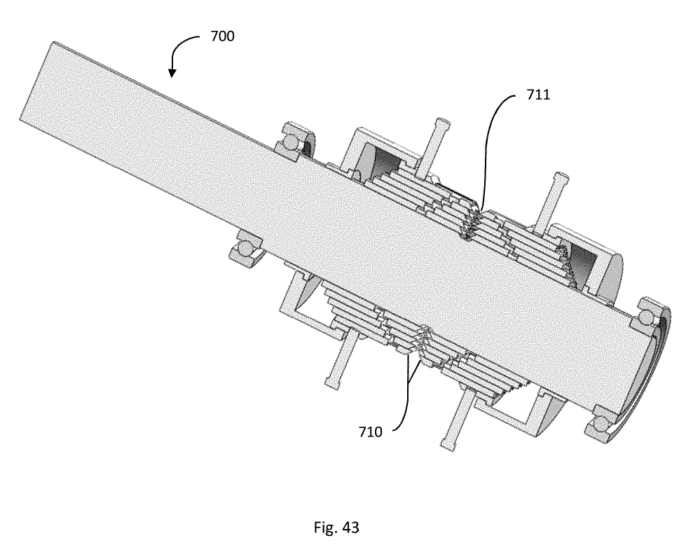

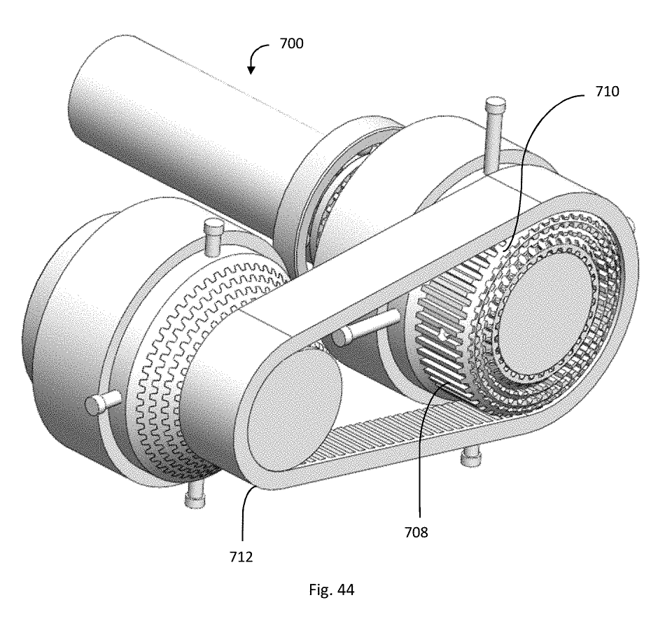

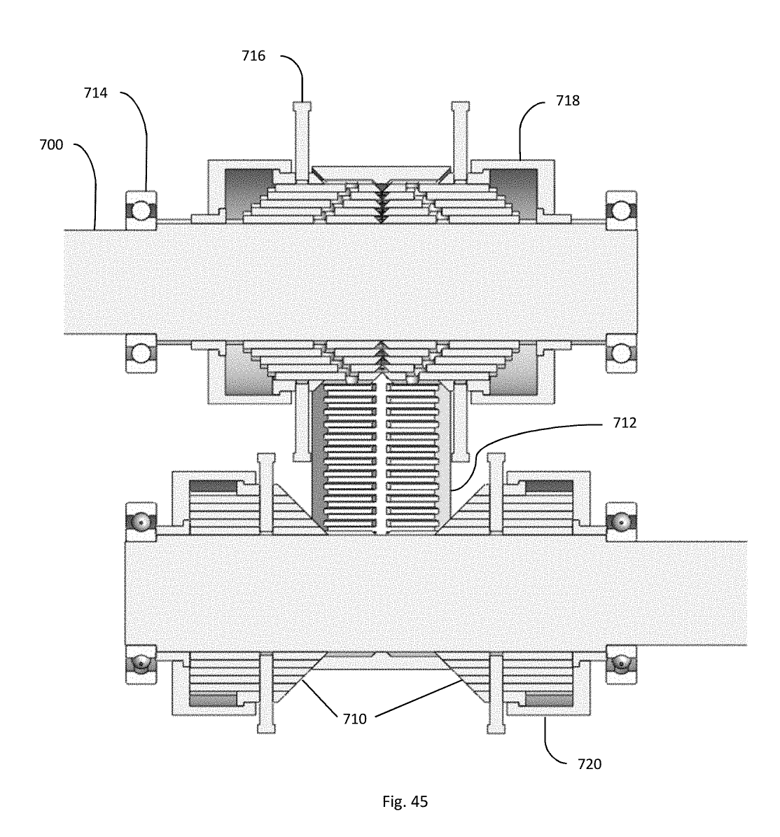

With continued reference to FIGS. 36-39, the various additional FIGS. 40-45 disclose example aspects of embodiments that employ a timing belt or chain. In particular, FIG. 40 discloses an input or output center drive shaft 700 with splines/teeth 702 and including a center belt/chain tracking groove 703, FIG. 41 discloses an example of a single nested gear 704, in which the leading edge 706 of the outer splines 708 can be chamfered to better guide the pulley into the belt/chain grooves, FIG. 42 discloses that as opposing nested gears are actuated toward the center, their tapered edges 710 cooperate to re-establish the center belt tracking groove 711, FIG. 43 is an axial cross section of the setup shown in FIG. 42, FIG. 44 discloses a radial cross section through a different plane of the setup shown in FIG. 42, and FIG. 45 discloses another cross section of the setup shown in FIG. 42 including bearings 714, selector pins 716, and gear cluster housing 718 and 720. In FIG. 44, only one side of the pulley formed by two sets of nested gears is shown and, likewise, only a half width of the belt/chain 712 is shown.

What is claimed is:

1. A portion of a transmission, comprising:
a first shaft;
a first gear cluster that includes a first plurality of coaxial nested gears that are movable in an axial direction relative to each other, the first plurality of coaxial nested gears including a first gear that is fixed to the first shaft; and
a self-centering mechanism that accommodates tolerance gaps between two successive gears of the first gear cluster.

2. The portion of a transmission of claim 1, wherein the self-centering mechanism comprises a plurality of bearing balls confined in a recirculating bearing path that is defined at least in part by two successive gears of the first gear cluster.

3. The portion of a transmission as recited in claim 2, wherein the bearing balls are configured to travel in both a radial direction and an axial direction relative to an axis defined by the first gear cluster.

4. The portion of a transmission as recited in claim 2, further comprising a retaining plate that cooperates with the two successive gears of the first gear cluster to define the recirculating bearing path.

5. The portion of a transmission as recited in claim 2, wherein each tooth of an outermost gear of the two successive gears takes the form of a cantilever.

6. The portion of a transmission as recited in claim 5, wherein the cantilever in each tooth is formed by a respective gap that extends from an outer surface of the tooth to the recirculating bearing path.

7. The portion of a transmission as recited in claim 2, wherein a bearing preload condition exists as a result of an interference between the root of the outer gear of the two successive gears and an upper surface of the recirculating bearing path.

8. A planetary gear system, comprising:
the portion of a transmission as recited in claim 1, wherein the portion is part of either an outer ring gear or a center sun gear; and
another set of nested gears configured for engagement with either the outer ring gear or the sun gear.

9. The portion of a transmission as recited in claim 1, further comprising:
a second shaft radially movable relative to the first shaft; and
a second gear cluster that includes a second plurality of coaxial nested gears that are movable in an axial direction relative to each other, the second plurality of coaxial nested gears including a first gear that is fixed to the second shaft.

10. The portion of a transmission as recited in claim 1, further comprising:
a second gear cluster that includes a second plurality of coaxial nested gears that are movable in an axial direction relative to each other, the second plurality of coaxial nested gears including a first gear that is fixed to the first shaft, and the first and second gear clusters axially spaced apart from each other along the first shaft.

11. The portion of a transmission as recited in claim 1, wherein a first one of the gears in the first gear cluster includes a spline arrangement that engages a corresponding spline arrangement of a second one of the gears in the first gear cluster such that the first and second gears are axially movable relative to each other, but the first and second gears cannot rotate relative to each other.

12. The portion of a transmission as recited in claim 11, wherein the first and second gears are configured to rotate in unison with each other.

13. The portion of a transmission as recited in claim 1, wherein a first gear of the first gear cluster is partly disposed in the interior of a second gear of the first gear cluster.

14. The portion of a transmission as recited in claim 1, wherein the gears in the first gear cluster all have a different respective diameter.

15. The portion of a transmission as recited in claim 1, further comprising a control device configured to engage one or more gears of the first gear cluster so as to extend and/or retract the one or more gears in an axial direction of the first shaft.

16. A vehicle, comprising:
the portion of a transmission as recited in claim 1;
a drive train connected to the portion of the transmission; and
a prime mover connectible to the drive train.

17. The vehicle as recited in claim 16, wherein the vehicle is one of a land vehicle, an aircraft, or a watercraft.
